(19) United States
(12) Patent Application Publication
(10) Pub. No.: US 2019/0020653 A1
(43) Pub. Date: Jan. 17, 2019

(54) METHOD AND APPARATUS FOR SECURE CROSS-SERVICE CONTENT SELECTION AND DELIVERY BASED ON MOBILE DEVICE IDENTITY

(71) Applicant: Averon US, Inc., Henderson, NV (US)

(72) Inventors: Wendell Brown, Henderson, NV (US); Mark Klein, Henderson, NV (US)

(21) Appl. No.: 16/033,775

(22) Filed: Jul. 12, 2018

Related U.S. Application Data
(60) Provisional application No. 62/531,682, filed on Jul. 12, 2017.

(51) Int. Cl. H04L 29/06; H04L 29/08; G06Q 30/02

(52) U.S. Cl. CPC H04L 63/0876; G06Q 30/0267; H04L 67/303

(57) ABSTRACT

Systems, apparatuses, methods, and computer program products are disclosed for providing secure cross-service content selection and delivery based on mobile device identity. An example method includes receiving, from a service provider, a mobile device identification request, the mobile device identification request comprising information configured to identify a mobile device and information configured to identify at least one third party service provider and determining, via a carrier header enrichment process, a carrier-confirmed mobile device identifier, the carrier-confirmed mobile device identifier comprising a one-way hash generated as a function of a phone number associated with the mobile device. The example method further includes generating a third party specific identifier as a function of the at least one third party service provider and the carrier-confirmed mobile device identifier, the third party specific identifier configured to identify a particular user or a particular mobile device without receiving personally identifiable information and causing the performance of a service, by the at least one third party service provider, by transmitting the third party specific identifier to the at least one third party service provider.

### CROSS REFERENCE TO RELATED APPLICATIONS

This application claims priority to U.S. Provisional Application No. 62/531,682, titled “Cross-Service Content Selection and Delivery Based on Mobile Device Identity,” filed Jul. 12, 2017, which is incorporated by reference herein in its entirety.

### TECHNOLOGICAL FIELD

Example embodiments of the present disclosure relate generally to methods of cross service content selection and delivery and, more particularly, to methods and apparatuses for providing secure cross-service content selection and delivery based on mobile device identity.

### BACKGROUND

The Internet lacks intrinsic methods for user identity confirmation. Service providers typically require a user to create an account using a user-generated username and a user-generated password. Some service providers require mobile phone number verification during the account creation process. The current industry standard method for mobile phone number verification, One Time Passcode (OTP) delivered via Short Message Service (SMS), has been deemed insecure by the National Institute of Standards and Technology (NIST). Therefore, millions of self-generated accounts exist without certain linkage to the mobile phone number stored in those account profiles.

Service providers typically require a user to log in to access services. Typically, a first party service provider provides a log in form to confirm the user's knowledge of a username and password. When the first party service provider fetches content, and/or requests services, from third party service providers, the third party service provider typically has to rely on the security policies of the first party service provider. In most situations, a third party service provider handles transactions as if the user were anonymous. In some situations, the third party is given information about the user through a delegated access scheme such as OAuth. In such cases, the third party may know the user has been authorized by the first party, but cannot independently confirm the user's identity which may severely limit the information that can be exchanged between the first and third parties. Compounding this issue, are privacy laws in some jurisdictions that constrain the personal information shared between service providers. For example, prohibiting the exchange of a user's phone numbers between service providers without the consent of the user.

Therefore, there is a need for methods and apparatuses capable of providing secure cross-service content selection and delivery based on mobile device identity without breaching the privacy of a user.

### BRIEF SUMMARY

Societal concerns over privacy have grown substantially in past years with the proliferation of IoT (the internet of things) devices. Data breaches in computer security systems previously thought of as secure have prompted many to second guess internet protections to their personal information. At the same time, the sheer number of third party services offered over the internet, each requiring a separate account with unique user generated login information, have caused many to lose track of the correct information associated with each particular service.

Embodiments disclosed herein describe systems, apparatuses, methods, and computer program products for delivering third party content and initiating third party actions, based on mobile device identity. The systems, apparatuses, methods, and computer products accept a request to identify a mobile device attempting to access a third party service and in response, generate a third party specific identifier based on information specific to the particular mobile device and the particular third party service provider. The identifier is then transmitted to one or more third party service providers for identification purposes. For example, a third party service provider may have one or more third party specific identifiers for each mobile device registered with the provider stored in memory. Using the stored third party identifiers, the third party service provider may identify a user without receiving personally identifiable information. Because the third party identifier is based on a carrier-confirmed mobile device, the user need not login. Moreover, by generating and transmitting a specific third party identifier, the systems, apparatuses, methods, and computer products disclosed herein may transmit information without the added risk of compromising a user's personal information. Thus, the systems, apparatuses, methods, and computer program products disclosed herein provide a safe, secure, and easy way for users to login and share information with multiple third party services.

In some example embodiments, a computer implemented method may be provided for providing secure cross-service content selection and delivery based on mobile device identity. The computer implemented method comprises receiving, from a service provider, a mobile device identification request, the mobile device identification request comprising information configured to identify a mobile device and information configured to identify at least one third party service provider, determining, via a carrier header enrichment process, a carrier-confirmed mobile device identifier, the carrier-confirmed mobile device identifier comprising a one-way hash generated as a function of a phone number associated with the mobile device, generating a third party specific identifier as a function of the at least one third party service provider and the carrier-confirmed mobile device identifier, the third party specific identifier configured to identify a particular user or a particular mobile device without receiving personally identifiable information, and causing the performance of a service, by the at least one third party service provider, by transmitting the third party specific identifier to the at least one third party service provider.

In some embodiments, the mobile device identification request is received from a third party service provider in response to a request for services associated with the third party service provider.

In some embodiments, the mobile device identification request includes user information sourced from one or more first party service providers.

In some embodiments, the computer implemented method further comprises storing, in a memory, the third party specific identifier with information associated with the third party specific identifier.

In some embodiments, generating the third party specific identifier further comprises encrypting the mobile device identifier using a hash function unique to the at least one third party service provider.

In some embodiments, causing performance of a service, by the at least one third party service provider, by transmitting the third party specific identifier to the at least one third party service provider includes transmitting information indicating an authorized user or mobile device with the third party specific identifier.

In some embodiments, the computer implemented method further comprises generating one or more content identifiers, wherein each of the one or more content identifiers include a content data structure providing information about one or more advertisements, associating the one or more content identifiers with the third party specific identifier, and storing, in a memory, the third party specific identifier with the one or more associated content identifiers.

In some embodiments, the computer implemented method further comprises generating one or more conversion reports by aggregating the one or more content identifiers associated with the third party specific identifier.

In some embodiments, the computer implemented method further comprises transmitting the one or more conversion reports with the third party specific identifier.

In some embodiments, the computer implemented method further comprises identifying one or more advertisements for display based on the one or more conversion reports; and transmitting the one or more identified advertisements with the third party specific identifier.

In some example embodiments, an apparatus may be provided for performing secure cross-service content selection and delivery based on mobile device identity, the apparatus comprising at least one processor and at least one memory including computer program code, the at least one memory and the computer program code configured to, with the processor, cause the apparatus to at least receive, from a service provider, a mobile device identification request, the mobile device identification request comprising information configured to identify a mobile device and information configured to identify at least one third party service provider, determine, via a carrier header enrichment process, a carrier-confirmed mobile device identifier, the carrier-confirmed mobile device identifier comprising a one-way hash generated as a function of a phone number associated with the mobile device, generate a third party specific identifier as a function of the at least one third party service provider and the carrier-confirmed mobile device identifier, the third party specific identifier configured to identify a particular user or a particular mobile device without receiving personally identifiable information, and cause the performance of a service, by the at least one third party service provider, by transmitting the third party specific identifier to the at least one third party service provider.

In some embodiments, the mobile device identification request is received from a third party service provider in response to a request for services associated with the third party service provider.

In some embodiments, mobile device identification request includes user information sourced from one or more first party service providers.

In some embodiments, the at least one memory and the computer program code are further configured to, with the processor, cause the apparatus to store in memory the third party specific identifier with information associated with the third party specific identifier.

In some embodiments, generating the third party specific identifier comprises encrypting the mobile device identifier using a hash function unique to the at least one third party service provider.

In some embodiments, causing the performance of a service, by the at least one third party service provider, by transmitting the third party specific identifier to the at least one third party service provider includes transmitting information indicating an authorized user or mobile device with the third party specific identifier.

In some embodiments, the at least one memory and the computer program code are further configured to, with the processor, cause the apparatus to generate one or more content identifiers, wherein each of the one or more content identifiers include a content data structure providing information about one or more advertisements, associate the one or more content identifiers with the third party specific identifier; and store, in a memory, the third party specific identifier with one or more associated content identifiers.

In some embodiments, the at least one memory and the computer program code are further configured to, with the processor, cause the apparatus to generate one or more conversion reports by aggregating the one or more content identifiers associated with the third party specific identifier.

In some embodiments, the at least one memory and the computer program code are further configured to, with the processor, cause the apparatus to transmit the one or more conversion reports with the third party specific identifier.

In some embodiments, the at least one memory and the computer program code are further configured to, with the processor, cause the apparatus to identify one or more advertisements for display based on the one or more conversion reports and transmit the one or more identified advertisements with the third party specific identifier.

Finally, in some example embodiments, a computer program product is provided for performing secure cross-service content selection and delivery based on mobile device identity, the computer program product comprising at least one non-transitory computer-readable storage medium having computer-executable program code instructions stored therein, the computer-executable program code instructions comprising program code instructions for receiving, from a service provider, a mobile device identification request, the mobile device identification request comprising information configured to identify a mobile device and information configured to identify at least one third party service provider; determining, via a carrier header enrichment process, a carrier-confirmed mobile device identifier, the carrier-confirmed mobile device identifier comprising a one-way hash generated as a function of a phone number associated with the mobile device; generating a third party specific identifier as a function of the at least one third party service provider and the carrier-confirmed mobile device identifier, the third party specific identifier configured to identify a particular user or a particular mobile device without receiving personally identifiable information; and causing the performance of a service, by the at least one third party service provider, by transmitting the third party specific identifier to the at least one third party service provider.

In some embodiments, the mobile device identification request is received from a third party service provider in response to a request for services associated with the third party service provider.

In some embodiments, the mobile device identification request includes user information sourced from one or more first party service providers.

In some embodiments, the computer-executable program code instructions further comprise program code instructions for storing in memory the third party specific identifier with information associated with the third party specific identifier.

In some embodiments, generating the third party specific identifier comprises encrypting the mobile device identifier using a hash function unique to the at least one third party service provider.

In some embodiments, causing the performance of a service, by the at least one third party service provider, by transmitting the third party specific identifier to the at least one third party service provider includes transmitting information indicating an authorized user or mobile device with the third party specific identifier.

In some embodiments, the computer-executable program code instructions further comprise program code instructions for generating one or more content identifiers, wherein each of the one or more content identifiers include a content data structure providing information about one or more advertisements; associating the one or more content identifiers with the third party specific identifier; and storing, in a memory, the third party specific identifier with one or more associated content identifiers.

In some embodiments, the computer-executable program code instructions further comprise program code instructions for generating one or more conversion reports by aggregating the one or more content identifiers associated with the third party specific identifier.

In some embodiments, the computer-executable program code instructions further comprise program code instructions for transmitting the one or more conversion reports with the third party specific identifier.

In some embodiments, the computer-executable program code instructions further comprise program code instructions for identifying one or more advertisements for display based on the one or more conversion reports; and transmitting the one or more identified advertisements with the third party specific identifier.

The foregoing brief summary is provided merely for purposes of summarizing some example embodiments illustrating some aspects of the present disclosure. Accordingly, it will be appreciated that the above-described embodiments are merely examples and should not be construed to narrow the scope of the present disclosure in any way. It will be appreciated that the scope of the present disclosure encompasses many potential embodiments in addition to those summarized herein, some of which will be described in further detail below.

### BRIEF DESCRIPTION OF THE FIGURES

Having described certain example embodiments of the present disclosure in general terms above, reference will now be made to the accompanying drawings, which are not necessarily drawn to scale. Some embodiments may include fewer or more components than those shown in the figures.

FIG. 1 illustrates a system in which some example embodiments may be used to provide cross-service content delivery across multiple third party systems based on the identity of a mobile device.

FIG. 2 illustrates a schematic block diagram of example circuitry embodying a device that may perform various operations in accordance with some example embodiments described herein.

FIGS. 3 and 4 illustrate example data flow diagrams, each showing an exemplary operation of an example system in accordance with embodiments described herein.

FIG. 5 illustrates an example flowchart for identifying a mobile device and initiating third party system action based on the mobile device identity, in accordance with some example embodiments described herein.

FIG. 6 illustrates an example flowchart for providing cross content delivery across multiple third party systems by associating content with unique third party specific identifiers, in accordance with some example embodiments described herein.

### DETAILED DESCRIPTION

Some embodiments of the present disclosure will now be described more fully hereinafter with reference to the accompanying figures, in which some, but not all embodiments of the disclosures are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

Where the specification states that a particular component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such terminology is intended to convey that the particular component or feature is included in some embodiments while excluded in others, or has the characteristic in some embodiments while lacking the characteristic in others.

A “computing device”, as used herein, may refer to a mobile devices utilizing mobile apps, computers using browsers, kiosks designed for a particular purpose, and/or physical devices, vehicles, locks (e.g., home or automobile entry or the like), home appliances and other items embedded with any of electronics, software, sensors, and/or actuators, as well as network connectivity which enables these objects to connect and exchange data.

The term “server” or “server device” is used to refer to any computing device capable of functioning as a server, such as a master exchange server, web server, mail server, document server, or any other type of server. A server may be a dedicated computing device or a server module (e.g., an application) an application hosted by a computing device that causes the computing device to operate as a server. A server module (e.g., server application) may be a full function server module, or a light or secondary server module (e.g., light or secondary server application) that is configured to provide synchronization services among the dynamic databases on computing devices. A light server or secondary server may be a slimmed-down version of server type functionality that can be implemented on a computing device, such as a smart phone, thereby enabling it to function as an Internet server (e.g., an enterprise e-mail server) only to the extent necessary to provide the functionality described herein.

The term “device identification information” as used herein refers to any information that may identify a computing device. For example, device identification information may refer to a user's subscriberID, which may be similar or the same as a mobile device's phone number/CallerID number, the mobile device's phone number, the mobile device's callerID number, International Mobile Equipment Identity (IMEI)/unique serial number (ICCID) data, network-based, MAC addresses, billing record's modem certificate, DOCSIS hub/Media Access Layer routing assignments, Cable modem's certificate, device serial number, etc., Intel vPro and Trusted Platform Module key, or the like. In a mobile context, device identification information may refer to a subscriber identification module (SIM), embodied by SIM cards, which are configured to store network-specific information used to authenticate and identify subscribers on a network, and may further be embodied by e-sims, programmable sims, virtual sims, apple sims, or the like, Universal Subscriber Identity Module (USIM), a Removable User Identity Module (R-UIM), or a CDMA Subscriber Identity Module (CSIM), any of which may be a software application or integrated circuit, for example, stored on a SIM card or Universal Integrated Circuit Card (UICC), may comprise at least a unique serial number (ICCID), an international mobile subscriber identity (IMSI) number, Authentication Key (Ki), Local Area Identity (LAI), and Operator-Specific Emergency Number. SIM cards also store other carrier specific information such as, for example, the SMSC (Short Message Service Center) number, Service Provider Name (SPN), Service Dialing Numbers (SDN), Advice-Of-Charge parameters, and Value Added Service (VAS) application. The SIM card, as referred to herein, may be a full, mini, micro, nano, virtual, programmable, software (e.g., “soft” sim), an Apple®, or an emdedded(e) SIM. In some embodiments, device identification information may be contained within, stored on, or otherwise embodied by an EMV (Europay, MasterCard and Visa) chip or an NFC (Near Field Communication) chip with, for example, unique account information.

Device identification information may be stored, transmitted, and/or received, in some embodiments, in a raw, tokenized, hashed, one-way hashed, encrypted, digitally signed, using public/private key encryption or other means of encrypting, or other similar algorithms (e.g., for system/customer/bank/wireless network/other privacy or other reasons) data form, or otherwise derived or transcoded from any of the above. A “network provider” as used herein may be, for example, wireless service provider, wireless carrier, cellular company, or mobile network carrier (e.g., Verizon, AT&T, T-Mobile, etc.) which may have data such as a user's name, billing address, equipment installation address, birthdate, tower routing/router information to the user's wireless device (e.g., mobile phone), IP WAN address, IP LAN address, IP DMZ info, wireless device equipment information (serial number, certificate number, model number, IMEI number etc.), and other information, that it could similarly supply to a third-party. Similarly, a “network provider” may be, for example, in those embodiments in which a user may access the internet through a wired connection (e.g., via cable, DSL, any non-wireless-phone-carrier means such as via a satellite dish system), a wired network provider. For example, a user's cable company (for example: cox cable) may have data such as a user's name, billing address, equipment installation address, birthdate, among other fields, cable wire routing/router information to the user's cable modem (home), IP WAN address, IP LAN address, IP DMZ info, cable modem equipment information (serial number, certificate number, model number, etc.), and other information, that it could similarly supply to a third-party.

A “network provider” as used herein may be, for example, wireless network provider (e.g., Verizon, AT&T, T-Mobile, etc.) which may have data such as a user's name, billing address, equipment installation address, birthdate, tower routing/router information to the user's wireless device (e.g., mobile phone), IP WAN address, IP LAN address, IP DMZ info, wireless device equipment information (serial number, certificate number, model number, IMEI number etc.), and other information, that it could similarly supply to a third-party.

Similarly, a “network provider” may be, for example, in those embodiments in which a user may access the internet through a wired connection (e.g., via cable, DSL, any non-wireless-phone-carrier means such as via a satellite dish system), a wired network provider. For example, a user's cable company (for example: cox cable) may have data such as a user's name, billing address, equipment installation address, birthdate, among other fields, cable wire routing/router information to the user's cable modem (home), IP WAN address, IP LAN address, IP DMZ info, cable modem equipment information (serial number, certificate number, model number, etc.), and other information, that it could similarly supply to a third-party.

A “third party service provider” as used herein may refer to, for example, any organization, person, company, government, or other entity seeking to provide a secure data environment, including, for example, a bank, an e-commerce company, an entertainment company, an TOT device/company, (TOT meaning internet of things), a fintech company, a social web company, a file storage company, or the like.

As used herein, a “match” may be detected, determined, and/or reported in, for example, a binary form or a more granular form (e.g., a score, for example, ranging from 0-100 or the like).

### Overview

As noted above, methods, apparatuses, systems, and computer program products are described herein that provide for cross service content selection and delivery based on mobile device identity. Traditionally, it has been very difficult to securely identify users of third party services without compromising personally identifiable information. In addition, there is typically no way for a third party service provider to independently identify users of third party services without compromising the privacy of the user.

In contrast to conventional techniques for identifying user's access privileges, the present disclosure describes delivering third party content and initiating or causing initiation of third party actions, based on mobile device identity. The present disclosure describes a system, method, apparatus, and computer program product that receives an identification request identifying a mobile device and a third party service provider. In response, the system, method, apparatus, and computer program product may then cause the mobile device to be securely and definitively identified. For example, the identification may be performed using carrier header enrichment and the result is a one-way hash transformed carrier-confirmed device mobile phone number. Based on the mobile device identification information and the third party service provider, the system, method, apparatus, and computer program product may generate a third party specific identifier and transmits the third party specific identifier to the third party service provider. Using the third party specific identifier, the third party service provider may be enabled, allowed, permitted, authorized, or otherwise caused to identify the user and grant access or perform an action based on user account information associated with the third party specific identifier. In this manner, the system, method, apparatus, and computer program product may communicate information sufficient to identify a user without delivering personally identifiable information that may otherwise compromise a user's privacy.

Accordingly, the present disclosure sets forth systems, methods, apparatus, and computer program products that provide sufficient information to a third party service provider to identify a user without compromising the user's personal information. There are many advantages of these and other embodiments described herein. For instance, by securely identifying the mobile device the system enables a third party service provider to securely present information on an unrelated website with no user login required. In this regard, the system provides heightened security more conveniently than conventional authentication systems. In addition, the system protects the user's personal information by further encrypting the mobile device identification information unique to each third party service provider. This additional step prevents a given third party's customer information from being correlated with another third party's customer information. Thus, providing enhanced security capabilities specific to using multiple service providers over the internet. Finally, the present disclosure enables third party service providers to provide targeted content to users. For example, the third party service provider may store customer information keyed to a third-party specific identifier. In this manner, the third party service provider may leverage user information without releasing or receiving personally identifiable information.

Although a high level explanation of the operations of example embodiments has been provided above, specific details regarding the configuration of such example embodiments are provided below.

### System Architecture

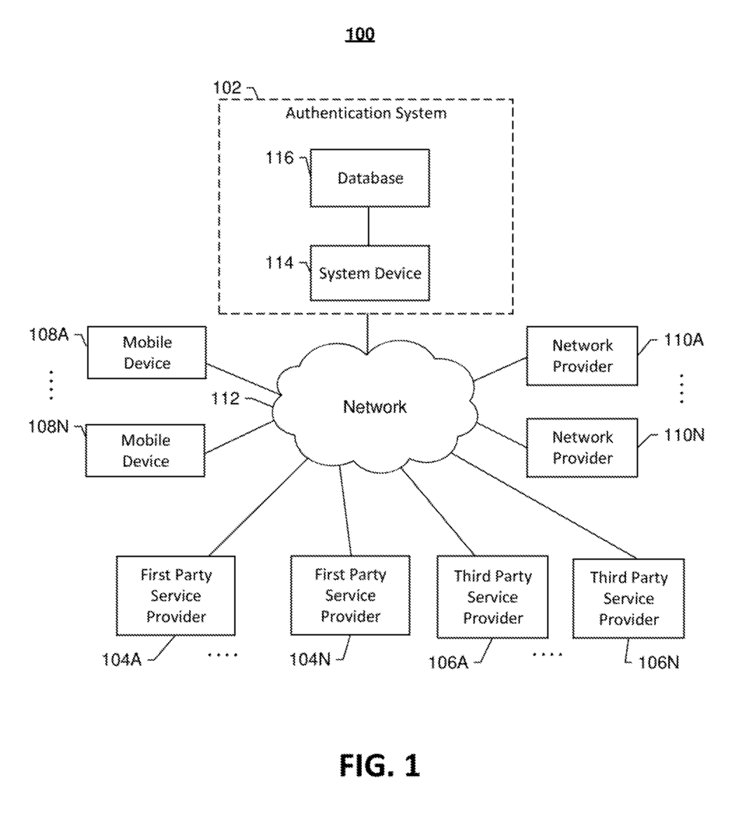

Example embodiments described herein may be implemented using any of a variety of computing devices or servers. To this end, FIG. 1 illustrates an example environment 100 within which embodiments of the present disclosure may operate to deliver third-party content and initiate third party actions as a function of a confirmed mobile device identity. As illustrated, an authentication system 102 may include one or more system devices 114 in communication with one or more databases 116. The authentication system 102 any of the constituent system devices 114 and/or database 116 may in turn receive information from, and transmit information to, one or more first party service providers 104A-104N, third party systems 106A-106N, mobile devices 108A-108N, and network providers 110A-110N.

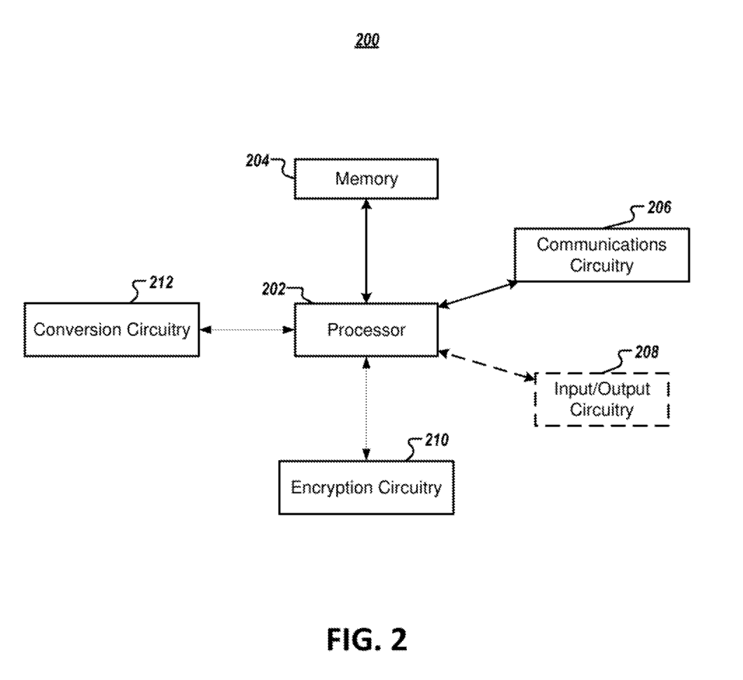

The one or more authentication system devices 114 may be embodied as one or more servers, such as that described below in connection with FIG. 2. The one or more authentication system devices 114 may further be implemented as local servers, remote servers, cloud-based servers (e.g., cloud utilities), or any combination thereof. The one or more authentication system devices 114 may receive, process, generate, and transmit data, signals, and electronic information to facilitate the operations of the authentication system 102. The one or more databases 116 may be embodied as one or more data storage devices, such as a Network Attached Storage (NAS) device or devices, or as one or more separate databases or servers. The one or more databases 116 may store information accessed by the authentication system 102 to facilitate the operations of the authentication system 102. For example, the one or more databases 116 may store control signals, device characteristics, and access credentials for one or more first party service providers 104A-104N, third party service providers 106A-106N, mobile devices 108A-108N, and network providers 110A-110N.

The one or more first party service providers 104A-104N, third party service providers 106A-106N, mobile devices 108A-108N, and network providers 110A-110N may be embodied by any computing devices known in the art. The authentication system 102 may receive information from, and transmit information to, the one or more first party service providers 104A-104N. For example, when a mobile device such as 108A performs a specific query a first party service provider such as first party service provider 104A, the first party service provider 104A may recognize that query as one potentially requiring services associated with one or more third party service providers 106A-106N. In such a case, the first party service provider 104A may transmit a request to the authentication system 102 to verify the identification of the mobile device 108A on behalf of the one or more third party service providers 106A-106N.

In addition, the authentication system 102 may receive information from, and transmit information to, the one or more third party service providers 106A-106N. For example when a mobile device such as mobile device 108A performs a query to a first party service provider such as first party service provider 104A that requires services associated with the one or more third party service providers 106A-106N the one or more third party service providers 106A-106N may transmit a request for mobile device identification to the authentication system 102 and receive a third party specific identifier identifying mobile device 108A in return.

In addition, the authentication system 102 may receive information from, and transmit information to, the one or more mobile devices 108A-108N such as mobile device 108A. For example, in response to receiving a request for mobile device identification from the one or more first party service providers 104A-104N and/or the one or more third party service providers 106A-106N the authentication system 102 may initiate header enrichment with the one or more mobile devices 108A-108N.

As used herein, header enrichment refers to authenticating a mobile device or an owner of the mobile device via a Direct Autonomous Authentication process, involving a packet header enrichment in which packet headers comprise device identification information, for example, “injected” therein by a trusted party such as a carrier, network provider or through a login process. For example, in some embodiments, one or more network providers 110A-110N may inject a phone number associated with a mobile device within packet headers. In this manner, the authentication system may obtain device identification information without user input. Application Ser. No. 15/424,595, entitled “Method and Apparatus for Facilitating Frictionless Two-Factor Authentication,” filed on Feb. 3, 2017, which is hereby incorporated by reference in its entirety, describes a number of exemplary processes for performing a Direct Autonomous Authentication process.

Finally, the authentication system 102 may receive information from, and transmit information to, the one or more network providers 110A-110N. For example, in response to initiating header enrichment with the one more mobile devices 108A-108N, the authentication system 102 may receive an indication of a carrier-confirmed mobile device phone number from the one or more network providers 110A-110N.

It will be understood that in some embodiments, the one or more first party service providers 104A-104N, third party service providers 106A-106N, mobile devices 108A-108N, and network providers 110A-110N need not themselves be independent devices, but may be peripheral devices communicatively coupled to other computing devices.

### Example Implementing Apparatuses

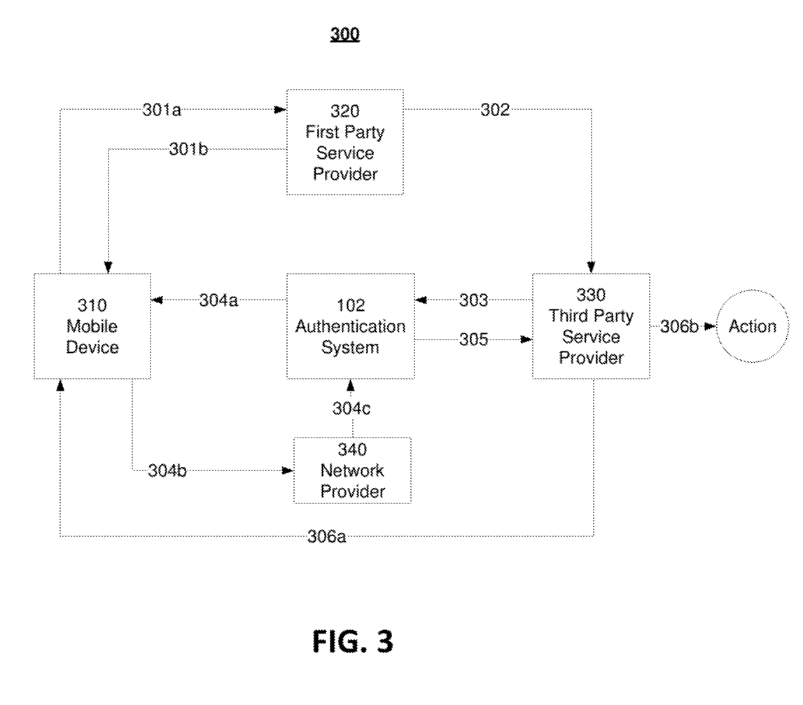

The authentication system 102 described with reference to FIG. 1 may be embodied by one or more computing devices or servers, such as the apparatus 200 shown in FIG. 2. As illustrated in FIG. 2, the apparatus 200 may include processing circuitry 202, memory 204, communications circuitry 206, input/output circuitry 208, encryption circuitry 210, and conversion circuitry 212, each of which will be described in greater detail below. In some embodiments, the apparatus 200 may further comprise a bus (not expressly shown in FIG. 2) for passing information between various components of the apparatus. The apparatus 200 may be configured to execute various operations described above in connection with FIG. 1 and below in connection with FIGS. 3-6.

In some embodiments, the processor 202 (and/or co-processor or any other processing circuitry assisting or otherwise associated with the processor) may be in communication with the memory 204 via a bus for passing information among components of the apparatus 200. The processor 202 may be embodied in a number of different ways and may, for example, include one or more processing devices configured to perform independently. Additionally or alternatively, the processor 202 may include one or more processors configured in tandem via a bus to enable independent execution of software instructions, pipelining, and/or multithreading. The use of the terms “processor” or “processing circuitry” may be understood to include a single core processor, a multi-core processor, multiple processors of the apparatus 200, remote or “cloud” processors, or any combination thereof.

In an example embodiment, the processor 202 may be configured to execute software instructions stored in the memory 204 or otherwise accessible to the processor. Alternatively or additionally, the processor 202 may be configured to execute hard-coded functionality. As such, whether configured by hardware or software methods, or by a combination of hardware with software, the processor 202 may represent an entity (e.g., physically embodied in circuitry) capable of performing operations according to an embodiment of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus 200 to carry out various functions in accordance with example embodiments contemplated herein.

The communications circuitry 206 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 206 may include, for example, a network interface for enabling communications with a wired or wireless communication network. For example, the communications circuitry 206 may include one or more network interface cards, antennas, buses, switches, routers, modems, and supporting hardware and/or software, or any other device suitable for enabling communications via a network. Additionally or alternatively, the communication interface 206 may include the circuitry for causing transmission of such signals to a network or to handle receipt of signals received from a network.

In some embodiments, the apparatus 200 may include input/output circuitry 208 in communication configured to provide output to a user and, in some embodiments, to receive an indication of user input. The input/output circuitry 208 may comprise a user interface, such as a display, and may further comprise the components that govern use of the user interface, such as a web browser, mobile application, dedicated client device, or the like. In some embodiments, the input/output circuitry 208 may additionally or alternatively include a keyboard, a mouse, a touch screen, touch areas, soft keys, a microphone, a speaker, and/or other input/output mechanisms. The input/output circuitry 208 may utilize the processor 202 to control one or more functions of one or more of these user interface elements through software instructions (e.g., application software and/or system software, such as firmware) stored on a memory (e.g., memory 204) accessible to the processor 202.

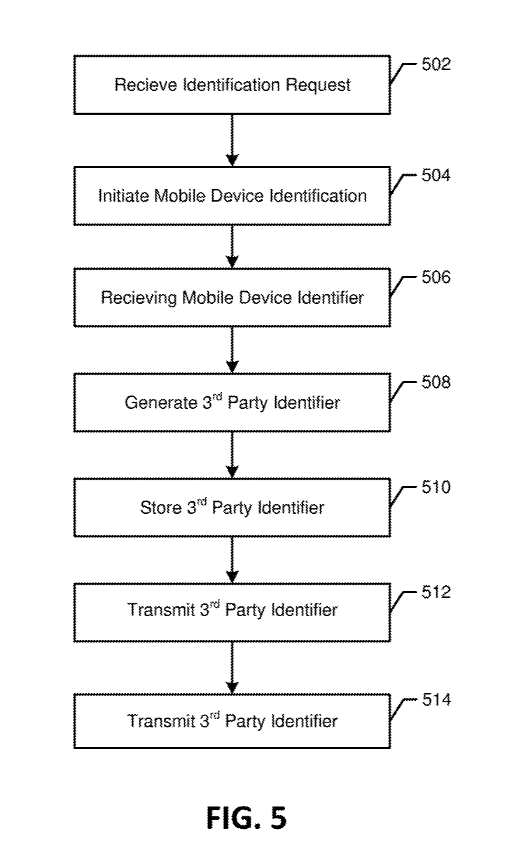

In addition, the apparatus 200 further comprises encryption circuitry 210, which includes hardware components designed for further encrypting device identification information as a function of a particular third party service provider such as third party service provider 106A of third party service providers 106A-106N. The encryption circuitry 210 may utilize processor 202, memory 204, or any other hardware component included in the apparatus 200 to perform these operations, as described in connection with FIG. 5 below. The encryption circuitry 210 may further utilize communications circuitry 206 to receive device identification information, or may otherwise utilize processor 202 and/or memory 204 to generate and store one or more third party specific identifiers as a function of the device identification information and third party service provider 106A-106N information.

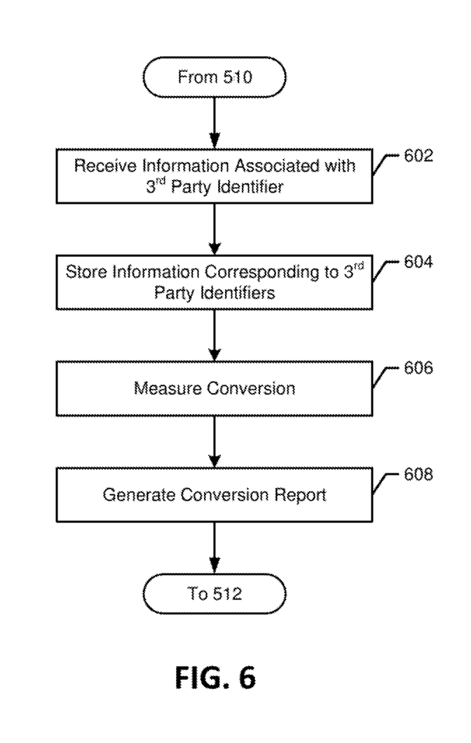

Finally, the apparatus 200 further comprises conversion circuitry 212, which includes hardware components designed for generating, analysing, and transmitting conversion data. The conversion circuitry 212 may utilize processor 202, memory 204, or any other hardware component included in the apparatus 200 to perform these operations, as described in connection with FIG. 6 below. The conversion circuitry 212 may further utilize communications circuitry 206 to receive content and transmit conversion data based on the received content, or may otherwise utilize processor 202 and/or memory 204 to generate, analyze, and store conversion data.

Although these components 202-212 may in part be described using functional language, it will be understood that the particular implementations necessarily include the use of particular hardware. It should also be understood that certain of these components 202-212 may include similar or common hardware. For example, the encryption circuitry 210, and conversion circuitry 212, may each at times leverage use of the processor 202 or memory 204, but duplicate hardware is not required to facilitate operation of these distinct components of the apparatus 200 (although duplicated hardware components may be used in some embodiments, such as those in which enhanced parallelism may be desired). The use of the term “circuitry” as used herein with respect to components of the apparatus therefore shall be interpreted as including the particular hardware configured to perform the functions associated with the particular circuitry described herein. Of course, while the term “circuitry” should be understood broadly to include hardware, in some embodiments, the term “circuitry” may refer also to software instructions that configure the hardware components of the apparatus 200 to perform their various functions.

To this end, each of the communications circuitry 206, input/output circuitry 208, encryption circuitry 210, and conversion circuitry 212, may include one or more dedicated processors, specially configured field programmable gate array (FPGA), or application specific interface circuit (ASIC) to perform its corresponding functions, these components may additionally or alternatively be implemented using a processor (e.g., processor 202) executing software stored in a memory (e.g., memory 204). In this fashion, the communications circuitry 206, input/output circuitry 208, encryption circuitry 210, and conversion circuitry 212, are therefore implemented using special-purpose components implemented purely via hardware design or may utilize hardware components of the apparatus 200 that execute computer software designed to facilitate performance of the functions of the communications circuitry 206, input/output circuitry 208, encryption circuitry 210, and conversion circuitry 212.

Having described specific components of example apparatus 200, example embodiments are described below in connection with a series of flowcharts.

### Exemplary Data Flow for Cross-Service Selection

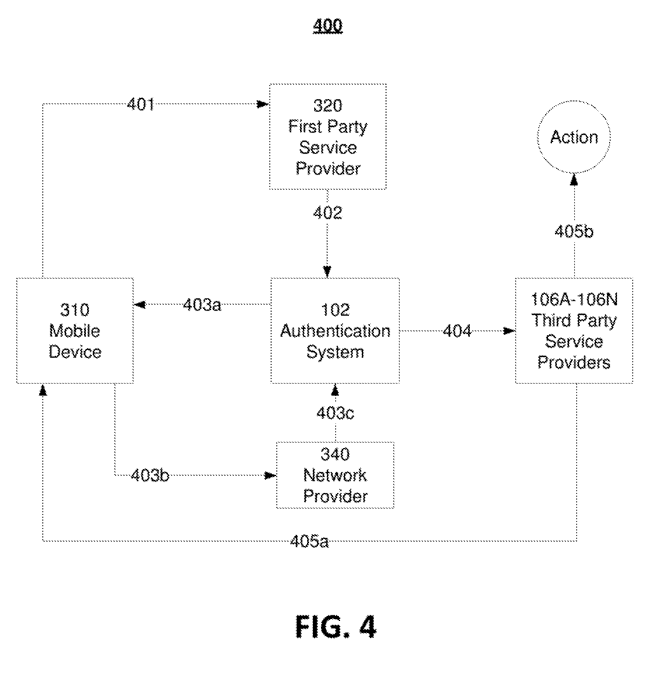

Turning to FIGS. 3 and 4, example data flows are illustrated that contain example operation implemented by example embodiments herein.

Turning first to FIG. 3, FIG. 3 depicts an example data flow 300 illustrating interactions between a mobile device, for example mobile device 310 such as one of the mobile devices 108A-108N, a first party service provider, for example first party service provider 320 such as one of the first party service providers 104A-104N, a third party service provider, for example third party service provider 330 such as one of the third party service providers 106A-106N, a network provider, for example network provider 340 such as one of the network providers 110A-110N, and the authentication system 102. The data flow 300 illustrates how electronic information may be passed among various systems in accordance with embodiments of the present invention.

At step 301a, the mobile device 310 and/or a user of the mobile device 310 performs a specific query to the first party service provider 320. In some embodiments, the user of the mobile device 310 may be a user of the first party service provider 320 and may be known to the third party service provider 330. In other embodiments, the user of the mobile device 310 may be anonymous to the first party service provider 320.

At step 301b, the first party service provider 320 may recognize the specific query performed at step 301a as one potentially requiring services associated with third party service provider 330. In response, first party service provider 320 content is returned to the user of mobile device 310. In some embodiments, those services are presented to the user of the mobile device 310 via an image with an associated link to the image-associated service.

At step 302, the first party service provider 320 requests third party services from the third party service provider 330 by providing a service request indicating the queried service and, for example, first device identification information associated with mobile device 310. Queried services may include, for example, the delivery of payment services, advertisements, promotion, loyalty points, and others. In response to the request for third party services from the first party service provider 320, at step 303, the third party service provider 330 forwards the first device identification information to the authentication system 102 along with an authentication request. The first device identification information may comprise one or more phone numbers associated with mobile device 310 and/or, in some embodiments, the first device identification information may be may be raw, tokenized, hashed, or otherwise transcoded or derived, for example, for security reasons.

The authentication system 102 then causes the mobile device 310 to be securely and definitively identified at steps 304a-304c. For example, this identification may be performed using carrier header enrichment and the result may be a one-way hash transformed carrier-confirmed device mobile phone number. For instance, the authentication system 102 may authenticate a mobile device and/or an owner of the mobile device via a Direct Autonomous Authentication process, involving a packet header enrichment in which packet headers comprise a second device identification information, for example, “injected” therein by a trusted party such as network provider 340. In alternative embodiments, device identification can be performed using SIM, IMEI, carrier account, and other device or user identifying methods such as self-sovereign identity stored on the mobile device 310.

In some embodiments, the network provider 340 may provide the second device identification information to the authentication system 102. The second device identification information as received from the network provider 340 may be raw, tokenized, hashed, or otherwise transcoded or derived, for example for security reasons. The authentication system 102 may then securely and definitely identify mobile device 108A by comparing the first and second device identification information. The comparison may first involve, for example, decoding the device identification information and comparing raw data or comparing transcoded information. The comparison may also involve, in some embodiments, normalization of the device identification information. That is, the first identification information may be in a convenient format, for example, for input or display within the user's online account—which may or may not include elements such as punctuation (e.g., dashes, parentheses, brackets, or the like), country codes, spaces, etc. the comparison may simply ignore such elements, strip the elements, or otherwise clean the data, etc.

For example, since a phone number is considered Personally Identifiable Information (PII), in some embodiments, it may be hashed by the network provider 340, the authentication system 102, and/or a billing aggregator (if used). The billing aggregator, although not shown in the diagram, is an optional service provider that aggregates carrier integrations. The hashed mobile phone number is further encrypted using a hash function, or other method, unique to each third party service provider 106A-106N. This additional step is performed to prevent a given third party service provider's customer information from being correlated with another third party service provider's customer information. Such correlation might compromise the privacy of a customer. For example, correlation could take place in the event of data breaches against multiple third parties or collusion among third parties.

At step 305, a third party specific hash of the confirmed mobile phone number may be returned to the third party service provider 330. In some embodiments, the third party service provider 330 has knowledge of its customers, indexed by the third party specific hash, for example, a phone number transformed by third-party specific hash. In this regard, the third party service provider 330 may look up mobile device 310 via the third party specific hash and determine appropriate services based on customer information. In this manner, the third party service provider 330 may tailor services to a specific mobile device without using personally identifiable information associated with mobile device 310.

Additionally or alternatively, the authentication system 102 may compare the third party specific identifier to one or more third party specific identifiers stored in memory 204. For example, the authentication system 102 may identify the third party service provider 330 associated with the third party specific identifier by matching the third party specific identifier to one of the one or more third party specific identifiers in memory 204. In this manner, the authentication system 102 may cause the third party service provider 106A to perform a particular service by transmitting the third party specific identifier along with information indicating an authorized user and/or mobile device.

In some embodiments, at step 306a the requested third party services are sent to the mobile device 310 in the form of third party selected content containing an image and a link for the user to access further services if they so choose. In other embodiments, at step 306b the requested third party services may include third party internal customer account changes, such as the addition of loyalty points, or external actions such as notification to another party.

The delivery of the selected content to the mobile device 310 may flow directly from the third party service provider 330 (e.g., steps 306a-306b), flow through the authentication system 102, flow through the first party service provider 320, and/or flow through both the authentication system 102 and the first party service provider 320. In an alternative embodiment, third party services can be delivered to the user of the mobile device 310 outside of the website or application session hosted by the first party. Such content can be delivered using SMS, phone call, e-mail, postal mail, or other methods.

Turning to FIG. 4, FIG. 4 depicts an alternative example data flow 400 illustrating interactions between a mobile device, for example mobile device 310 such as one of the mobile devices 108A-108N, a first party service provider, for example first party service provider 320 such as one of the first party service providers 104A-104N, one or more third party service providers, for example one or more third party service providers 106A-106N, a network provider, for example network provider 340 such as one of the network providers 110A-110N, and the authentication system 102 where the phone number confirmation is performed by the first party service provider 320. The data flow 400 illustrates how electronic information may be passed among various systems in accordance with alternative embodiments of the present invention.

At step 401, the mobile device 310 and/or a user of the mobile device 310 performs a specific query to the first party service provider 320. The first party service provider 320 may recognize the specific query performed at step 301 as one potentially requiring services associated with one or more third party service providers 106A-106N.

In response, at step 402, the first party service provider 320 requests services associated with the one or more third party service providers 106A-106N by providing a service request indicating the queried service and, for example, first device identification information associated with mobile device 301 to the authentication system 102.

The authentication system 102 causes the mobile device to be securely and definitively identified at steps 403a-403c. For example, this identification may be performed using carrier header enrichment and the result may be a one-way hash transformed carrier-confirmed device mobile phone number. For instance, the authentication system 102 may authenticate a mobile device and/or an owner of the mobile device via a Direct Autonomous Authentication process, involving a packet header enrichment in which packet headers comprise a second device identification information, for example, “injected” therein by a trusted party such as network provider 340. In alternative embodiments, device identification can be performed using SIM, IMEI, carrier account, and other device or user identifying methods such as self-sovereign identity stored on the mobile device 310.

In some embodiments, the network provider 340 may provide the second device identification information such as a phone number associated with mobile device 108A and/or a hashed version of a phone number associated with the mobile device 108A to the authentication system 102. The authentication system 102 may then securely and definitely identify mobile device 108A by comparing the first and second device identification information.

At step 404, a third party specific hash of the confirmed mobile phone number is then transmitted to the one or more third party service providers 106A-106N along with a request for services associated with one or more of the third party service providers 106A-106N. In some embodiments, each third party service provider of the third party service providers 106A-106N has knowledge of its customers, indexed by a unique, third party specific, hash, for example, a phone number transformed by a third-party specific hash function. In this regard, each third party service provider of the third party service providers 106A-106N may look up mobile device 310 via the third party specific hash and determine appropriate services based on customer information. In this manner, the third party service provider associated with the third party specific hash may tailor services to a specific mobile device without using personally identifiable information associated with mobile device 310.

In a preferred embodiment, at step 405a the requested third party services are returned to the mobile device 310 in the form of third party selected content containing an image and a link for the user to access further services if they so choose. In other embodiments, at step 405b the requested third party services may include third party internal customer account changes, such as the addition of loyalty points, or external actions such as notification to another party.

The delivery of the selected content to the mobile device 310 may flow directly through the authentication system 102, flow directly from the one or more third party service providers (e.g., steps 405a-405b), flow through the first party service provider 320, and/or flow through both the authentications system 102 and the first service provider 320.

### Example Operations for Cross-Service Content Selection

Turning to FIGS. 5 and 6, example flowcharts are illustrated that contain example operations implemented by example embodiments described herein. The operations illustrated in FIGS. 5 and 6 may, for example, utilize or be performed by one or more of the apparatuses shown in FIG. 1, and described in FIG. 2, such as apparatus 200, which illustrates an example authentication system 102. For example, the various operations described in connection with FIGS. 5, and 6 may be performed by an apparatus 200, which may utilize one or more of processing circuitry 202, memory 204, communications circuitry 206, communications circuitry 208, encryption circuitry 210, conversion circuitry 212, and/or any combination thereof.

Turning first to FIG. 5, example operations are shown for secure cross-service content selection and delivery based on mobile device identity.

As shown by operation 502, the apparatus 200 includes means, such as processing circuitry 202, memory 204, and communications circuitry 208, or the like, for receiving, from a service provider, a mobile device identification request, the mobile device identification request comprising information configured to identify a mobile device and information configured to identify at least one third party service provider. In some embodiments, the authentication system 102 receives a mobile identification request from one or more first party service providers 104A-104N and/or one or more third party service providers 106A-106N.

For instance, in some embodiments, a third party service provider such as third party service provider 106A from third party service providers 106A-106N may request the identification of a mobile device such as mobile device 108A from mobile devices 108A-108N from the authentication system 102. In this regard, the user of mobile device 108A may perform a specific query to a first party service provider such as first party service provider 104A from the first party service providers 104A-104N. In response, first party service provider 104A may recognize that query as potentially requiring service associated with third party service provider 106A. For example, first party service provider 104A may present services associated with third party service provider 106A as an image with an associated link to an image-associated service. A user associated with the mobile device 108A may query services associated with third party service provider 106A by selecting the link associated with the services of the third party service provider 106A. In response to the user's query, the first party service provider 104A may display content associated with the first party service provider 104A via the mobile device 108A and request content and/or actions associated with the third party service provider 106A from the third party service provider 106A. The third party service provider 106A may, in turn, transmit a mobile device identification request identifying the mobile device 108A and the third party service provider 106A to the authentication system 102. In this manner, the authentication system 102 may receive a mobile device identification request from third party service provider 106A.

Additionally or alternatively, in some embodiments, the first party service provider 104A may request mobile device identification from the authentication system 102. In this regard, after a user associated with mobile device 108A performs a specific query to the first party service provider 104A and the first party service provider 104A may recognize that query as potentially requiring services associated with one or more third party service providers 106A-106N. In response, the first party service provider 104A may transmit a mobile device identification request identifying the mobile device 108A and at least one third party service provider 106A to the authentication system 102. In this manner, the authentication system 102 may receive a mobile device identification request from first party service provider 104A.

As used herein, the mobile device identification request may include any first information pertaining to one or more first party service providers 104A-104N, one or more third party service providers 106A-106N, and/or one or more mobile devices 108A-108N. For example, the mobile device identification request may include first device identification information such as a phone number associated with the mobile device 108A and/or a hashed version of a phone number associated with the mobile device 108A.

Moreover, as discussed in further detail with reference to FIG. 6, in some embodiments the mobile identification request may include user information pertinent to a particular third party service's content selection process. For instance, in some embodiments, user information may be sourced from one or more first party service provider generated sessions (i.e. shopping basket contents) and/or from a user's account profile (i.e. demographics) associated with a first party service provider.

As shown by operation 504, the apparatus 200 may include means, such as processing circuitry 202, memory 204, communications circuitry 206, and encryption circuitry 210, or the like, for initiating mobile device identification in response to receiving the mobile device identification request described above. In this regard, the authentication system 102 may respond to a mobile device identification request by causing the mobile device 108A associated with the mobile identification request to be securely and definitely identified. In some embodiments, this identification is performed using carrier header enrichment and the result is a one way hash transformed carrier-confirmed mobile device phone number. For example, the authentication system 102 may authenticate a mobile device or an owner of the mobile device via Direct Autonomous Authentication process, involving packet header enrichment in which packet headers comprise second device identification information, for example, “injected” therein by a trusted party such as one or more network providers 110A-110N. Application Ser. No. 15/424,595, entitled “Method and Apparatus for Facilitating Frictionless Two-Factor Authentication,” filed on Feb. 3, 2017, which is hereby incorporated by reference in its entirety, describes a number of exemplary processes for performing a Direct Autonomous Authentication process.

Alternative or additionally, in some embodiments, the mobile device identification can be performed using SIM, IMEI, carrier account, and other devices or user identifying methods such as self-sovereign identity stored on the mobile device 108A.

As shown by operation 506, the apparatus 200 includes means, such as processing circuitry 202, memory 204, communications circuitry 206, encryption circuitry 210, or the like, for determining, via a carrier header enrichment process, a carrier-confirmed mobile device identifier, the carrier-confirmed mobile device identifier comprising a one-way hash generated as a function of a phone number associated with the mobile device. In some embodiments, one or more network providers 110A-110N may provide the second device identification information such as a phone number associated with mobile device 108A and/or a hashed version of a phone number associated with the mobile device 108A to the authentication system 102. The authentication system 102 may determine a carrier-confirmed mobile device identifier for mobile device 108A by comparing first device identification information included in the mobile device identification request and second device identification information obtained from the one or more network providers 110A-110N. For instance, the authentication system 102 may determine a carrier-confirmed mobile device identifier if the first device identification information matches the second device identification information.

In some embodiments, the authentication system 102 may receive, via the communications circuitry 206, a carrier-confirmed mobile device identifier from the mobile device 108A through one or more network providers 110A-110N. In this regard, the one or more network providers (e.g., mobile phone carriers) 110A-110N may use personally identifiable information associated with the mobile device 108A to confirm the identity of the mobile device 108A. In some embodiments, in order to protect the privacy of the user of the mobile device, the one or more network providers 110A-110N may send an encrypted mobile device identifier rather than personally identifiable information. For example, the one or more network providers 110A-110N may generate a mobile device identifier by hashing the phone number associated with mobile device 108A and transmit the mobile device identifier rather than the phone number. In this regard, the mobile device identifier may comprise a one-way hash generated as a function of a mobile phone number associated with the mobile device 108A. In other embodiments, the authentication system 102 may protect the privacy of a user associated with mobile device 108A by generating the mobile device identifier, for example, by hashing a phone number associated with mobile device 108A. Moreover, the system may include a billing aggregator that, although not shown in the diagram, may be an optional service provider that aggregates network provider 110A-110N integrations. In another, alternative embodiment, the billing aggregator, where implemented, may generate the mobile device identifier, for example, by hashing the phone number associated with the mobile device 108A.

As shown by operation 508, the apparatus 200 includes means, such as processing circuitry 202, memory 204, communications circuitry 206, input-output circuitry 208, encryption circuitry 210, and conversion circuitry 212, or the like, for generating a third party specific identifier as a function of the at least one third party service provider and the carrier-confirmed mobile device identifier, the third party specific identifier configured to identify a particular user or a particular mobile device without receiving personally identifiable information. To increase security, encryption circuitry 210 may utilize information associated with third party service provider 106A to further encrypt the mobile device identifier by generating a third party specific identifier unique to the third party service provider 106A. For instance, the encryption circuitry 210 may further encrypt the mobile device identifier using a hash function, or other method, unique to each third party service provider 106A. Unlike conventional network security systems, this additional step is performed to prevent customer information associated with a given third party service provider 106A from being correlated with customer information associated with another third party service provider such as one or more third party service providers 106A-106N. Such correlation might compromise the privacy of a customer. For example, correlations may take place in the event of data breaches against and/or collusion among the one or more third party service providers 106A-106N.

As shown by operation 510, the apparatus 200 may include means, such as processing circuitry 202, memory 204, communications circuitry 206, input-output circuitry 208, encryption circuitry 210, and conversion circuitry 212, or the like, for storing, in a memory, the third party specific identifier. In some embodiments, the authentication system 102 may store a copy of each generated third party specific identifier within memory 204. Moreover, as discussed in greater detail below with reference to FIG. 6, the authentication system 102 may receive information associated with each generated third party specific identifier, such as transaction history, and store the information in memory 204 with each corresponding third party specific identifier.

As shown by operation 512, the apparatus 200 includes means, such as processing circuitry 202, memory 204, communications circuitry 206, input-output circuitry 208, encryption circuitry 210, and conversion circuitry 212, or the like, for causing performance of a service, by the at least one third party service provider, by transmitting the third party specific identifier to the at least one third party service provider. In some embodiments, after generating the third party specific identifier, the authentication system 102 transmits, via communications circuitry 206, the third party specific identifier to third party service provider 106A. In alternative embodiments, the authentication system 102 may transmit the third party specific identifier to one or more third party service providers 106A-106N. Moreover, in addition or alternatively the authentication system 102 may transmit information associated with the third party specific identifier to the one or more third party service providers 106A-106N along with the corresponding third party specific identifier.

As shown by operation 514, the apparatus 200 includes means, such as processing circuitry 202, memory 204, communications circuitry 206, input-output circuitry 208, encryption circuitry 210, and conversion circuitry 212, or the like, for causing performance of a service, by the at least one third party service provider, by transmitting the third party specific identifier to the at least one third party service provider. For example, the third party service provider 106A may receive and recognise the third party specific identifier, for instance, by comparing the third party specific identifier to data in memory. In some embodiments, where the mobile device identification yields a one-way hash of the user's mobile phone number, the third party service provider 106A may associated the one-way hash (i.e. the third party specific identifier) with customer information stored by the third party service provider 106A. For example, in some embodiments, the third party service provider 106A may store information of one or more customers, indexed by the same third party specific identifier. The third party service provider 106A may identify an authorized user via the third party specific identifier, and if authorized, the third party specific service provider may engage in the one or more actions requested by the mobile device 108A. The services may be supplied to mobile device 108A directly, by the third party service provider 106A, and/or indirectly by the authentication system 102, and/or indirectly by the first party service provider 104A, and/or any combination of the three. For example, selected content may be delivered to the mobile device 108A directly from the third party service provider 106A, flow through the authentication system 102, and/or flow through the first party system 104A. Moreover, in an alternate embodiment, third party services can be delivered to the user outside of the website or application session hosted by the first party service provider 104A. For instance, such content can be delivered using SMS, phone call, e-mail, postal mail, or other methods.

Alternatively or additionally, the authentication system 102 may compare the third party specific identifier to one or more third party specific identifiers stored in memory 204. For example, the authentication system 102 may identify a particular third party service provider 106A associated with the third party specific identifier by matching the third party specific identifier to one of the one or more third party specific identifiers in memory 204. In this manner, the authentication system 102 may cause the third party service provider 106A to perform a particular service by transmitting the third party specific identifier along with information indicating an authorized user and/or mobile device.

In a preferred embodiment, the services are provided to the user of the mobile device 108A in the form of third party selected content containing an image and a link for the user to access further services. In other embodiments, the services may include internal customer account changes associated with the particular third party service provider 106N. For example, changes may include the addition of loyalty points. Additionally or alternatively, the service may indicate external actions such as providing a notification to another party. Moreover, the services may be tailored to the individual account holder. For example, in the case of Internet shopping cart checkout, the service may indicate a set of available credit cards from which an individual account holder can select to complete the transaction. Moreover, in the exemplary internet shopping scenario, a third party service provider 106A may be a credit card issuer. In this case, the third party service provider 106A may accept transaction size information from the authentication system 102 as an input to its content selection algorithm. The resulting content delivered to the mobile device 108A might provide a discount, reward, or other promotion.

As described above, example embodiments provide methods and apparatuses that enable improved cross service content delivery among third party service providers 106A-106N. Example embodiments thus provide tools that overcome the security problems inherent in computer networks. By encrypting personally identifiable information such as a phone number associated with a mobile device 108A the methods and apparatuses described above allow users of mobile devices 108A-108N to use and share information with third party service providers 106A-106N over the internet without harming the integrity of the user's privacy. Moreover, embodiments described herein avoid the need to remember log in credential for the countless third party service providers available over the internet because the user identity may be obtained without user input. Finally, the embodiments described herein add a novel additional layer of protection by providing a unique encryption for personally identifiable information for each third party service provider 106A-106N. This additional layer of protection increases the security of conventional network security systems and unlocks many potentially new functions that have historically not been available, such as the ability share information among multiple third party service providers 106A-160N without risking a user's privacy.

Turning next to FIG. 6, example operations are shown for storing and delivering content such as targeted advertisements to a mobile device.

As shown by operation 602, the apparatus 200 may include means, such as processing circuitry 202, memory 204, communications circuitry 206, input-output circuitry 208, encryption circuitry 210, conversion circuitry 212, or the like, for receiving information associated with the third party specific identifier. The authentication system 102, may accept information associated with mobile device 108A and/or a user associated with the mobile device 108A. For example, the mobile device identification request may, in some embodiments, include user information pertinent to the content selection process of the third party service provider 106A such as, for example, session data and/or user account information sourced from the first party service provider 104A.

Moreover, the authentication system 102, may determine one or more attributes of the mobile device 108A associated with the third party specific identifier. For example, the authentication system 102 may determine a carrier who owns a phone number associated with mobile device 108A. In addition to or alternatively the authentication system 102 may determine attributes of a user associated with the mobile device 108A, such as demographics including gender and age. In some embodiments, the authentication system 102 may receive external data from one or more external data sources that supply additional information associated with mobile device 108A such as user demographics, psychographics, one or more email addresses, credit history, etc. In this regard, the external data sources may be accessed in real-time or by batch imports into the authentication system 102.

In some embodiments, the one or more third party service providers 106A-106N and/or the authentication system 102 may receive third party content delivered to a mobile device 108A. For example, the one or more third party service providers 106A-106N and/or the authentication system 102 may log one or more advertisements transmitted to each of the one or more mobile devices 108A-108N. Moreover, in some embodiments, the one or more third party service providers 106A-106N and/or the authentication system 102 may track the transaction history associated with each of the one or more mobile devices 108A-108N. For instance, the one or more third party service providers 106A-106N and/or the authentication system 102 may monitor the one or more mobile devices 108A-108N for user activity such as signing up for a bank account advertised for by one of the one of more third party service providers 106A-106N.

In some embodiments, the authentication system 102, may receive transaction history and/or content information from the one or more third party service providers 106A-106N. In some embodiments, the authentication system 102, may receive transaction information and/or content information by having the entity that controls the target transaction integrate mobile number identification into the transaction and/or by having a plain text phone number associated with the transaction hashed by the authentication system 102. In this manner, the authentication system 102 may log transaction data by hashing the mobile device information in real-time or in batch processes.

As shown by operation 604, the apparatus 200 may include means, such as processing circuitry 202, memory 204, communications circuitry 206, input-output circuitry 208, encryption circuitry 210, conversion circuitry 212, or the like, for storing one or more content identifiers corresponding to one or more third party specific identifiers. In some embodiments, the authentication system may be configured to store, in a memory 204, content and transaction information associated with a third party specific identifier with the corresponding third party identifier.

In some embodiments, the conversion circuitry 212 may be configured to generate one or more content identifiers for content associated with each of the one or more third party specific identifiers. In a preferred embodiment, the third party specific identifier is unique to each of the one or more third party systems 106A-106N and/or mobile devices 108A-108N. In some embodiments, the content identifiers may identify one or more advertisements. The content identifiers may include a content data structure providing information about one or more advertisements such as conversion rates, effectiveness scores, etc.

In some embodiments, the conversion circuitry 212 may identify received content associated with third party service provider 106A and/or mobile device 108A and associate the particular content with third party service provider 106A and/or mobile device 108A. In some embodiments, the conversion circuitry 212 may be configured to keep a record of the content delivered to mobile device 108A and/or a user associated with mobile device 108A by associating the one or more content identifiers with the user's telephone number represented by the hash of that number.

Moreover, the conversion circuitry 212 may be configured to keep a record of the content delivered to mobile device 108A and/or a user associated with mobile device 108A by associating the one or more content identifiers with the third party specific identifier. In this manner, the authentication system 102 may keep a record of content delivered to one or more mobile devices 108A-108N by the one or more third party service providers 106A-106N represented by the third party specific identifier. In addition or alternatively, in some embodiments the authentication system may associate transaction data with one or more third party specific identifiers. For example, when mobile device 108A executes a subsequent transaction with third party service provider 106A, such as signing up for a bank account advertised by third party service provider 106A, that transaction may be associated with the third party specific identifier. In some embodiments, the authentication system 102 may store transaction history on a blockchain in memory 204 which allows for subsequent transaction verification. For instance, the authentication system 102 may associate content originally delivered by the one or more third party service providers 106A-106N to the one or more mobile devices 108A-108N with subsequent transactions made between the one or more third party service providers 106A-106N and the one or more mobile devices 108A-108N.

As shown by operation 606, the apparatus 200 may include means, such as processing circuitry 202, memory 204, communications circuitry 206, input-output circuitry 208, encryption circuitry 210, conversion circuitry 212, or the like, for measuring conversion rates. In some embodiments, the conversion circuitry 212 may be further configured to measure conversion rates of the one or more advertisements identified by the one or more content identifiers. In this regard, the conversion circuitry 212 may measure conversion by cross-referencing the content identifiers with the transaction history associated with mobile device 108A. For instance, if the one or more third party service providers 106A-106N and/or the authentication system 102 records content delivered to the mobile device 108A and the action suggested in the advertisement is subsequently performed by the mobile device 108A (as indicated by the transaction history) the conversion circuitry 212 may determine a conversion associated with the advertisement. In some embodiments, the authentication system 102 may measure conversion in real time. However, in other embodiments the authentication system 102 measures conversion in batched processes.

As shown by operation 608, the apparatus 200 may include means, such as processing circuitry 202, memory 204, communications circuitry 206, input-output circuitry 208, encryption circuitry 210, conversion circuitry 212, or the like, for generating one or more conversion reports based on conversion measurements. For instance, the conversion circuitry 212 may generate one or more conversion reports by aggregating the one or more content identifiers. In some embodiments, the conversion reports may show conversion rates and/or advertisement effectiveness. In this manner, many industry standard reports may be generated, including reporting that shows the propensity to convert based on number of advertisement exposures. The one or more conversion reports may be associated with one or more third party specific identifiers. Moreover, in some embodiments, the authentication system 102 may transmit the one or more conversion reports to one or more third party service providers 106A-106N with the corresponding third party specific identifier. Moreover, in some embodiments, the conversion circuitry 212 may identify one or more advertisements for display based on the one or more conversion reports and transmit the one or more identified advertisements to one or more third party service providers 106A-106N with the third party specific identifier.

As described above, example embodiments provide methods and apparatuses that enable improved cross-service content selection and delivery by associating user and mobile device information with a unique third party identifier. Example embodiments provide tools that overcome security problems faced by conventional content sharing systems by associating relevant information with a encrypted third party identifiers. In this manner, example embodiments provide a secure environment capable of uniquely catering to a particular user's needs, while also eliminating the possibility of a breach in the user's privacy.

FIGS. 5, and 6 illustrate flowcharts describing sets of operations performed by apparatuses, methods, and computer program products according to various example embodiments. It will be understood that each block of the flowcharts, and combinations of blocks in the flowcharts, may be implemented by various means, embodied as hardware, firmware, circuitry, and/or other devices associated with execution of software including one or more software instructions. For example, one or more of the operations described above may be embodied by software instructions. In this regard, the software instructions which embody the procedures described above may be stored by a memory of an apparatus employing an embodiment of the present invention and executed by a processor of that apparatus. As will be appreciated, any such software instructions may be loaded onto a computer or other programmable apparatus (e.g., hardware) to produce a machine, such that the resulting computer or other programmable apparatus implements the functions specified in the flowchart blocks. These software instructions may also be stored in a computer-readable memory that may direct a computer or other programmable apparatus to function in a particular manner, such that the software instructions stored in the computer-readable memory produce an article of manufacture, the execution of which implements the functions specified in the flowchart blocks. The software instructions may also be loaded onto a computer or other programmable apparatus to cause a series of operations to be performed on the computer or other programmable apparatus to produce a computer-implemented process such that the software instructions executed on the computer or other programmable apparatus provide operations for implementing the functions specified in the flowchart blocks.

The flowchart blocks support combinations of means for performing the specified functions and combinations of operations for performing the specified functions. It will be understood that one or more blocks of the flowcharts, and combinations of blocks in the flowcharts, can be implemented by special purpose hardware-based computer systems which perform the specified functions, or combinations of special purpose hardware and software instructions.

In some embodiments, some of the operations above may be modified or further amplified. Furthermore, in some embodiments, additional optional operations may be included. Modifications, amplifications, or additions to the operations above may be performed in any order and in any combination.

### Example Use Scenarios

Consider the following scenarios, employing an example embodiment of the present invention. In one scenario, the first party service provider 104A may be a merchant or merchant billing service such as the service operated by the company Shopify. During checkout, the first party service provider 104A may use the authentication system to request payment options from third party service provider 106A such as Apple Corporation's Apple Pay. The Apple Pay third party service provider 106A may then use the Apple Pay specific identifier to determine if the mobile device 108A is associated with an existing Apple customer with an active Apple Pay account and/or is a device capable of supporting Apple Pay. The content may be returned to the mobile device 108A in the form of a payment option and may include a promotional discount for the activation of an Apple Pay account or a promotional discount for using the third party service provider 108A to complete the checkout process. The third party service provider 108A returned content may be one of many payment options returned by the authentication system 102 or presented to the user by the first party service provider independent of the authentication system 102. Moreover, the authentication system 102 may work with a multitude of third party payment services that could bid for the user's selection by offering competitive promotions. This competition may be performed with or without each of the one or more third party service providers 106A-106N knowing the existence and/or identity of other bidding third party service providers 106A-106N. In other embodiments, third party service provider's 106A-106N existence and identity can be shared among the third party service providers 106A-106N by the authentication system 102.

The user can interact with the first party service provider 104A using a web browser or an application running on the user's mobile device 108A. A first party service provider's 104A application running on the user's mobile device 108A may forward mobile device information in the request to the authentication system 102 for third party services. This device information can be used by a third party service provider 106A in its content selection process. An example of mobile device information is the status of an Apple Pay account on the mobile device 108A. A user may have one or more third party service provider 106A applications on their mobile device 108A. Third party service provider 106A selected content may include a notification or other content delivery to the user via the third party service provider's 106A application.

In another exemplary scenario, a credit card payment may be completed with a first party service provider 104A (i.e. an online merchant). At that time, a notified third party service provider 106A may offer the user the option, with or without promotion, to add the third party service provider's 106A payment method to the online merchant's 104A payment service.

Finally, in another exemplary scenario, the first party service provider 104A may be associated with a car manufacturer. The mobile device's 108A proximity to a registered vehicle, using Near-field communication (NFC) or other proximity determination technology, is sent to the car manufacturer's 104A network. In this case, the query to the car manufacturer 104A is implicit in the proximity of the mobile device 108A. The third party service provider 106A may be a mobile phone manufacturer, such as Samsung. If the mobile device 108A is registered in the mobile phone manufacturer 106A database as restricted during vehicle operation, the content delivered to the mobile device 108A would disable selected functions while the vehicle is being operated.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A computer implemented method for providing secure cross-service content selection and delivery based on mobile device identity comprising:
receiving, from a service provider, a mobile device identification request, the mobile device identification request comprising information configured to identify a mobile device and information configured to identify at least one third party service provider;
determining, via a carrier header enrichment process, a carrier-confirmed mobile device identifier, the carrier-confirmed mobile device identifier comprising a one-way hash generated as a function of a phone number associated with the mobile device;
generating a third party specific identifier as a function of the at least one third party service provider and the carrier-confirmed mobile device identifier, the third party specific identifier configured to identify a particular user or a particular mobile device without receiving personally identifiable information; and
causing the performance of a service, by the at least one third party service provider, by transmitting the third party specific identifier to the at least one third party service provider.

2. The method of claim 1, wherein the mobile device identification request is received from a third party service provider in response to a request for services associated with the third party service provider.

3. The method of claim 1, wherein the mobile device identification request includes user information sourced from one or more first party service providers.

4. The method of claim 13, further comprising:
storing, in a memory, the third party specific identifier with information associated with the third party specific identifier.

5. The method of claim 1, wherein generating the third party specific identifier comprises:
encrypting the mobile device identifier using a hash function unique to the at least one third party service provider.

6. The method of claim 1, wherein causing performance of a service, by the at least one third party service provider, by transmitting the third party specific identifier to the at least one third party service provider includes transmitting information indicating an authorized user or mobile device with the third party specific identifier.

7. The method of claim 1, further comprising:
accepting one or more content identifiers, wherein each of the one or more content identifiers include a content data structure providing information about one or more advertisements;
associating the one or more content identifiers with the third party specific identifier; and
storing, in a memory, the third party specific identifier with the one or more corresponding content identifiers.

8. The method of claim 7, further comprising:
generating one or more conversion reports by aggregating the one or more content identifiers associated with the third party specific identifier;

9. The method of claim 8, further comprising:
transmitting the one or more conversion reports with the third party specific identifier.

10. The method of claim 8, further comprising:
identifying one or more advertisements for display based on the one or more conversion reports; and
transmitting the one or more identified advertisements with the third party specific identifier.

11. An apparatus for performing secure cross-service content selection and delivery based on mobile device identity, the apparatus comprising at least one processor and at least one memory including computer program code, the at least one memory and the computer program code configured to, with the processor, cause the apparatus to at least:
receive, from a service provider, a mobile device identification request, the mobile device identification request comprising information configured to identify a mobile device and information configured to identify at least one third party service provider;
determine, via a carrier header enrichment process, a carrier-confirmed mobile device identifier, the carrier-confirmed mobile device identifier comprising a one-way hash generated as a function of a phone number associated with the mobile device;
generate a third party specific identifier as a function of the at least one third party service provider and the carrier-confirmed mobile device identifier, the third party specific identifier configured to identify a particular user or a particular mobile device without receiving personally identifiable information; and
cause the performance of a service, by the at least one third party service provider, by transmitting the third party specific identifier to the at least one third party service provider.

12. The apparatus of claim 11, wherein the mobile device identification request is received from a third party service provider in response to a request for services associated with the third party service provider.

13. The apparatus of claim 1, wherein the mobile device identification request includes user information sourced from one or more first party service providers.

14. The apparatus of claim 13, wherein the at least one memory and the computer program code are further configured to, with the processor, cause the apparatus to:
store in memory the third party specific identifier with information associated with the third party specific identifier.

15. The apparatus of claim 11, wherein generating the third party specific identifier comprises:
encrypting the mobile device identifier using a hash function unique to the at least one third party service provider.

16. The apparatus of claim 11, wherein causing the performance of a service, by the at least one third party service provider, by transmitting the third party specific identifier to the at least one third party service provider includes transmitting information indicating an authorized user or mobile device with the third party specific identifier.

17. The apparatus of claim 11, wherein the at least one memory and the computer program code are further configured to, with the processor, cause the apparatus to:
generate one or more content identifiers, wherein each of the one or more content identifiers include a content data structure providing information about one or more advertisements;
associate the one or more content identifiers with the third party specific identifier; and
store, in a memory, the third party specific identifier with one or more associated content identifiers.

18. The method of claim 17, wherein the at least one memory and the computer program code are further configured to, with the processor, cause the apparatus to:
generate one or more conversion reports by aggregating the one or more content identifiers associated with the third party specific identifier.

19. The apparatus of claim 18, wherein the at least one memory and the computer program code are further configured to, with the processor, cause the apparatus to:
transmit the one or more conversion reports with the third party specific identifier.

20. The apparatus of claim 18, wherein the at least one memory and the computer program code are further configured to, with the processor, cause the apparatus to:
identify one or more advertisements for display based on the one or more conversion reports; and
transmit the one or more identified advertisements with the third party specific identifier.

21. A computer program product for, performing secure cross-service content selection and delivery based on mobile device identity, the computer program product comprising at least one non-transitory computer-readable storage medium having computer-executable program code instructions stored therein, the computer-executable program code instructions comprising program code instructions for:
receiving, from a service provider, a mobile device identification request, the mobile device identification request comprising information configured to identify a mobile device and information configured to identify at least one third party service provider;
determining, via a carrier header enrichment process, a carrier-confirmed mobile device identifier, the carrier-confirmed mobile device identifier comprising a one-way hash generated as a function of a phone number associated with the mobile device;
generating a third party specific identifier as a function of the at least one third party service provider and the carrier-confirmed mobile device identifier, the third party specific identifier configured to identify a particular user or a particular mobile device without receiving personally identifiable information; and
causing the performance of a service, by the at least one third party service provider, by transmitting the third party specific identifier to the at least one third party service provider.

22. The computer program product according to claim 21, wherein the mobile device identification request is received from a third party service provider in response to a request for services associated with the third party service provider.

23. The computer program product according to claim 21, wherein the mobile device identification request includes user information sourced from one or more first party service providers.

24. The computer program product according to claim 23, wherein the computer-executable program code instructions further comprise program code instructions for:
storing in memory the third party specific identifier with information associated with the third party specific identifier.

25. The computer program product according to claim 21, wherein generating the third party specific identifier comprises:
encrypting the mobile device identifier using a hash function unique to the at least one third party service provider.

26. The computer program product according to claim 21, wherein causing the performance of a service, by the at least one third party service provider, by transmitting the third party specific identifier to the at least one third party service provider includes transmitting information indicating an authorized user or mobile device with the third party specific identifier.

27. The computer program product according to claim 21, wherein the computer-executable program code instructions further comprise program code instructions for:
generating one or more content identifiers, wherein each of the one or more content identifiers include a content data structure providing information about one or more advertisements;
associating the one or more content identifiers with the third party specific identifier; and
storing, in a memory, the third party specific identifier with one or more associated content identifiers.

28. The computer program product according to claim 27, wherein the computer-executable program code instructions further comprise program code instructions for:
generating one or more conversion reports by aggregating the one or more content identifiers associated with the third party specific identifier.

29. The computer program product according to claim 28, wherein the computer-executable program code instructions further comprise program code instructions for:
transmitting the one or more conversion reports with the third party specific identifier.

30. The computer program product according to claim 28, wherein the computer-executable program code instructions further comprise program code instructions for:
identifying one or more advertisements for display based on the one or more conversion reports; and
transmitting the one or more identified advertisements with the third party specific identifier.
